(19) United States
(12) Patent Application Publication
(10) Pub. No.: US 2021/0034773 A1
(43) Pub. Date: Feb. 4, 2021

(54) System for Role Based Granular Access Control over Document Content and Media: Method and Apparatus

(71) Applicants: Saeed Rajput, Boca Raton, FL (US); Basit Hussain, Tampa, FL (US)

(72) Inventors: Saeed Rajput, Boca Raton, FL (US); Basit Hussain, Tampa, FL (US)

(21) Appl. No.: 16/941,533

(22) Filed: Jul. 29, 2020

Related U.S. Application Data
(60) Provisional application No. 62/881,368, filed on Aug. 1, 2019.

(51) Int. Cl. G06F 21/62; H04L 9/08; H04L 9/14; H04L 9/30; G06F 21/64; G06F 21/60

(52) U.S. Cl. CPC G06F 21/6218; H04L 9/0869; H04L 9/0825; G06F 21/602; H04L 9/3073; G06F 21/64; H04L 9/14

(57) ABSTRACT

This invention allows granular protection of individual components of a single document, which allows users to access only the information they are authorized to view. The document is available for viewing under the same protection even when the document is accessed offline. The components of the document that are viewable by a specific recipient are based on the roles of that recipient. Thus, role based access control model is used as the security model.

### CROSS REFERENCE TO RELATED APPLICATIONS

This application claims priority to U.S. Provisional Application 62/881,368 entitled: “A System for Role Based Granular Access Control over Document Content and Media: Method and Apparatus”, file by the same inventors on Aug. 1, 2019.

### BACKGROUND

Maintaining control of digital information and content to limit exposure to intended recipients and blocking access to the unauthorized users has been problematic since the inception of the Internet. The invention of printing press made it easier to deliver information to the masses. However, the copying process was slow, and it was possible for the content creators to get return on their investment by placing a price on each copy of their work. With the invention of photocopying machine, cost of making unauthorized copies went down. The process was still slow and it was possible to use legal and mutual-cooperation mechanisms to capture unauthorized mass-publishers. Similarly, initial cost of duplication of multimedia content was high (film), but with the advent of magnetic and optical technologies, cost of duplication dropped. Analogous to printed media, it was still possible to control the distribution using legal mechanisms. Internet has made distribution of digitized media and information fast and economical, which has made controlling it very difficult. New laws such as United States' Digital Millennium Copyright Act and the European Union's Copyright Directive are examples of legal efforts to allow content creators to exert control on how the content is used.

Under a different set of concerns, certain information must be protected from a certain group of individuals (A) to preserve privacy of various parties (B), to meet policy or legal requirements. We will refer to the information that needs to be protected as “classified”. Traditionally, such protections can only be provided by either redaction of the classified information, or by keeping classified information in separate containers, documents or even on different servers.

Controlling access to classified information is easier when it is maintained independently. However, this makes it difficult to for the recipient to understand the context of the information when several crisscrossing citations are used to refer to multiple documents with different classes of access.

Redaction can provide privacy, but it requires multiple versions of the same information, each intended for a different class of audience. This makes it harder to maintain these documents if they are “living” documents that are updated repeatedly. Furthermore, once the complete document is released to authorized users, it is difficult to maintain control over its duplication and distribution.

Conventional mechanism for enforcing such control is to restrict access to such documents through centralized “servers” that release the appropriate level of classified information to the users after verifying their identities through authentication processes. Subsequent protection of information is controlled based on legal or policy structure that imposes severe penalties for unintended use or disclosure of classified information by properly authenticated users. Such secondary enforcements are easier for the government and by the companies over their employers, but are harder to do by entities that have little or no enforcement authority over authorized users.

In 1996, Ravi Sandhu proposed Role Based Access Control (RBAC) that provided far more flexible access control over information that was available earlier under the multilayered Mandatory or Discretionary Access Control (MAC, and DAC) policies where information could only be classified at different level on a linear scale. RBAC made it possible to implement “need-to-know” and “compartmentalized” access controls, in a non-linear fashion, while allowing for flexible administration of access controls based on roles. Implementation of RBAC has been slow. History of unauthorized leaks has made it clear that the implementations are lacking. Furthermore, implementations of RBAC are limited to control of real-time, online access of information and services where data is usually well-structured and broken into well-defined components.

In 2009, Bitcoin software was released by a person or group under the fictitious name of “Satoshi Nakamoto”. Amongst several other innovations such as finding a solution to a longstanding computer science “consensus” for a specific problem, it also introduced the concept of cryptographically linked list of records by using hash pointers. Such a list can be used as a tamper-evident log of events or records.

### SUMMARY OF INVENTION

This invention allows granular protection of individual components of a single document, which allows users to access only the information they are authorized to view. The document is available for viewing under the same protection even when the document is accessed offline. The components of the document that are viewable by a specific recipient are based on the roles of that recipient. Thus, role based access control model is used as the security model.

The preferred embodiment of this invention provides a completely self-contained document container that is capable of protecting its contents without immediate assistance from a centralized server. This container also provides tamper-evidence log that provides proof of how many people have viewed the document making it possible to detect duplications through the lifecycles of the document.

An alternative embodiment of the invention provides server based access to decryption keys, and server based tamper-evidence log.

### BRIEF DESCRIPTION OF THE DRAWINGS

FIG. 1: Schematic diagram of Granular Document Access Control System

FIG. 2: Example of Document Components in a Sample Text Document.

FIG. 3: Example of Serial model Document Components in a Sample Text Document represented as a line segment.

FIG. 4: The Document Component shown as a class as a UML class.

FIG. 5: Creating Disjoint Document Components by the invention when Sender indicates desire to create overlapping document component with different scenarios.

FIG. 6: Document Component Hierarchy of example shown in FIG. 1.

FIG. 7: Document Component Hierarchy of example shown in FIG. 5 (DC is abbreviation for Document Component)

FIG. 8: Indexing system for the Document Component Hierarchy

FIG. 9: Indexing of Roles for the direct children of a Document Component

FIG. 10: Process of protecting a Document Component for several Roles

FIG. 11: The process of Protection of the Entire Document

FIG. 12: The Directions of repeated encryption and decryption processes on the document tree

FIG. 13: Decryption process of a Document Component

FIG. 14: The UML class representation of Role class

FIG. 15: The class diagram of Document and related classes.

FIG. 16: Cipher Suite Associated with Document Component in Alternative embodiment of the Invention.

### DETAILED DESCRIPTION OF THE PREFERRED EMBODIMENT

All forms of information that are collected on a recipient's device such as a stream or a file for the purpose of rendering, printing, viewing, playing, or any other form of automated consumption of information are considered documents by this invention. Therefore, a document can be the usual text document with or without rich text formatting for specific rendering by an application such as a word processor, web browser or other application available on the computer or mobile platform of the recipient. A document can also be media such as video or a sound file in any format. It can also be data that is transported between distinct applications, services, containers or servers for purpose of consumption by a process, a service, an application or a server. A person with ordinary skill in the art would recognize that the mode of delivery of the document is an independent concept. Documents are often broken into pieces for efficient and error-free delivery to a computer or a device with mechanisms such as torrents. For similar reasons, media and other large files are often delivered as streams in a manner that they are played or consumed by a process, service, application, computer or device before the entire file is assembled as a single unit, and part of the information downloaded earlier that has already been played, consumed, viewed, or rendered is removed from the computer or device before the end of the file is downloaded to make room for the further download. Conceptually, such streams are also considered “documents” even though, the entire file may never reside within the recipient's process, application, service, device or computer at any given time.

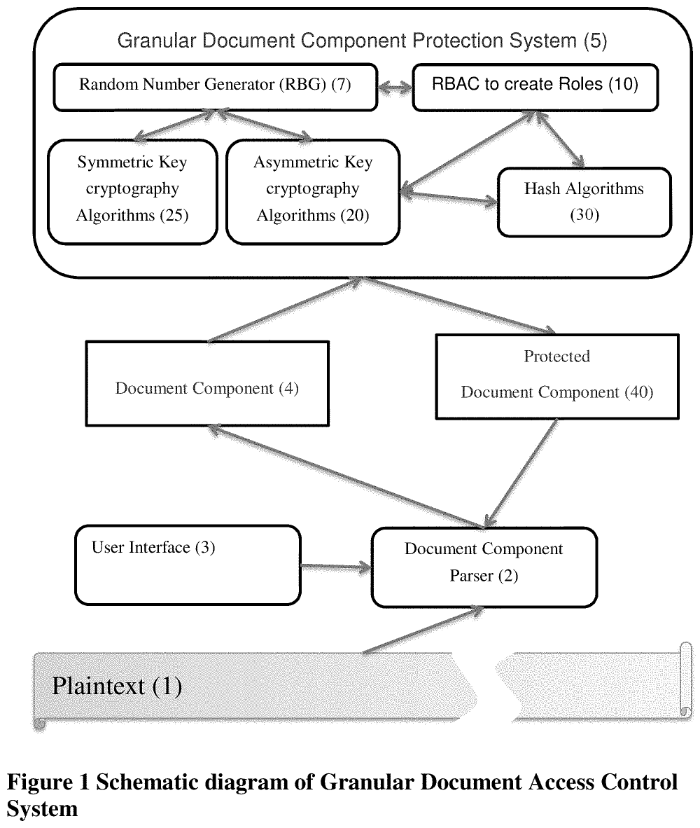

This invention shown in FIG. 1 protects plurality of disjoint components of text or multi-media documents. Each document (1) is treated as a stream. The document component parser (2) parses the document into plurality of document components (4) based on the intention of the user captured through a user interface (3). Using the user interface (3), the user can simply indicate the roles that can view specific portions of the document. Document parser (2) transforms the intention of the user that maps these access roles to the content portions of the text or multimedia document that is treated as a stream, into disjoint document components (4) as described in the remainder of this discloser.

In addition to the User Interface (3) and Document Component (2) the preferred embodiment of this invention also comprises the Granular Document Component Protection System (5). The Granular Document Component Protection System (5) further comprises a random number generator (7), a plurality of asymmetric-key cryptographic algorithms (20), a plurality of symmetric key cryptographic algorithms (25) that system supports, a plurality of hash algorithms (30) that the system supports, and a role based access control system (10).

The said random number generator (7) is capable of providing adequate randomness to support generation of public-private keys for plurality of asymmetric key algorithms that the system supports. The said plurality of asymmetric-key cryptographic algorithms (20) are adequate to encrypt small pieces of data such as symmetric keys of a plurality of symmetric key algorithms that the system supports as well as to provide integrity and non-repudiation to a piece of text or multi-media data. The said plurality of symmetric key cryptographic algorithms (25) are adequate to encrypt any piece of text or multi-media data. The said plurality of hash algorithms (30), where each is used to provide integrity and non-repudiation in conjunction with one of the said public key algorithms and is also used to provide a hash of the public key that acts as a unique identifier. The said role based access control system (10) creates roles each with associated public-private key pair and associates that role to a document component (4).

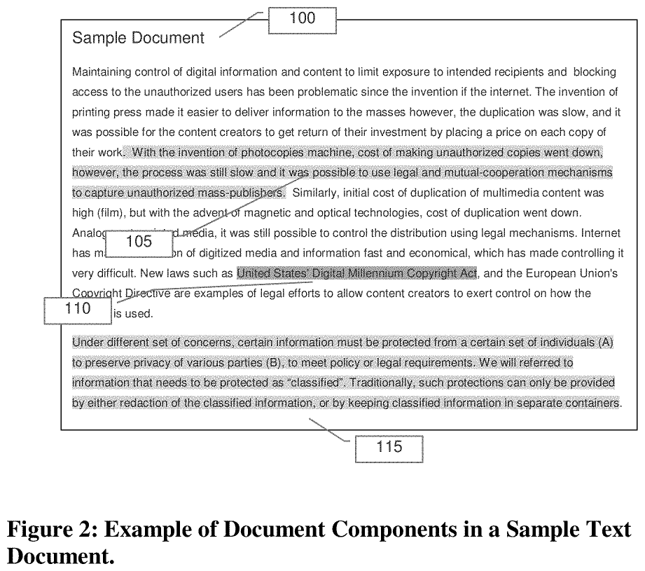

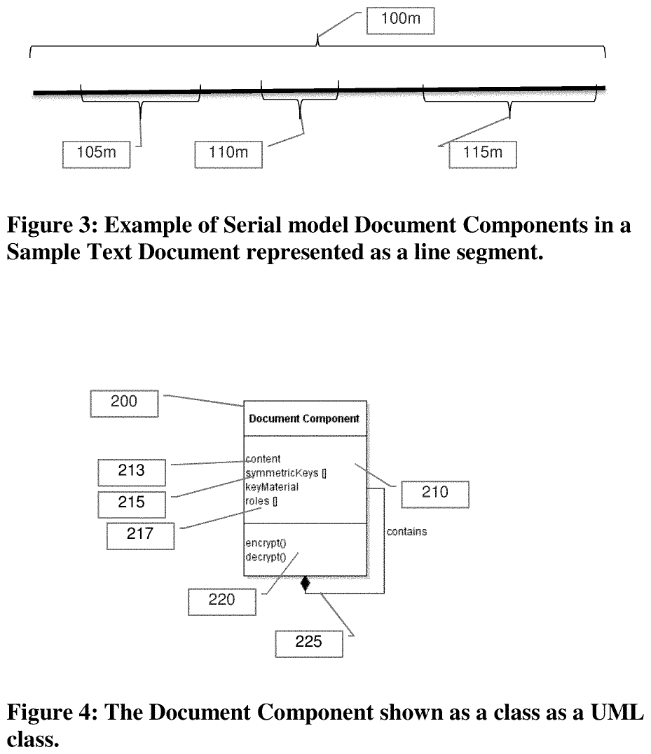

FIG. 2 shows examples of “Document Component” in a sample text document (100). This invention treats any contiguous subset of a given document or media that needs to be protected as a document component. In a text document, a document segment can be any contiguous subset ranging from a single word (not shown), a group of contiguous words (110), a complete sentence (105), a contiguous group of sentences (not shown), a complete paragraph (115), a contiguous group of paragraphs (not shown), a complete heading or a sub-heading (not shown), complete document (100) and any other artifact such as table, figure, picture, or embedded media (not shown). This same document is modelled as a line segment (100m) in FIG. 3 and the document components 100, 105, 110 and 115 of FIG. 1, are modeled by sub segments 100m, 105m, 110m and 115m, respectively. A person with ordinary skills in the art will realize that a media document can also have a component which is any contiguous time period segment as clear from the model in FIG. 3.

Every document component is treated as an object which is shown as a simplified UML class (200) in FIG. 4. Class diagrams in UML have three parts: 1) Class Name (Document Component), 2) Attributes (210) that represent information maintained, controlled and processed by the class and 3) functions (220) also sometimes called methods that facilitate dynamic behavior of the class. Document Component class maintains the content (213), which could be in plaintext form or ciphertext form depending on the state of the object of this class. The symmetric keys and key material (215) are needed to encrypt or decrypt the document component based on the algorithm prescribed by the cipher suite selected for the document or the document component. As a person with ordinary skill in the art will recognize, cipher suite specifies all the algorithms needed for protection, the sizes of keys, block sizes, output size (for hash algorithm) and the size of and conditions needed on the Initialization Vectors (IV).

The structure of key material is determined by the cipher suite of the Document. Document Component also has a list of one or more “roles” (217). The functions encrypt( ) and decrypt( ) (220) are used to change the state of the content of the document component from plaintext to ciphertext and vice versa as a person with ordinary skills in the field would recognize. Note that the symmetricKeys is a list and not a single key. During encryption, a randomly generated key is first used to encrypt the document component. After this process this key is maintained as the first member of this list. After roles have been assigned to this document component, this key is further encrypted by the public key of each role and added to this list. The original symmetric encryption is removed from this list once the entire document is protected for all recipients. Only its encrypted versions, one each for every role that must have access to the content of the document component is maintained in the list.

The aggregation relationship (225) indicates that a Document Component can recursively “contain” other Document Components. Each child document component contained by a given parent document component is a contiguous disjoint subset of its parent. It is easy to see that the document components form a hierarchical non-binary tree that will be discussed later.

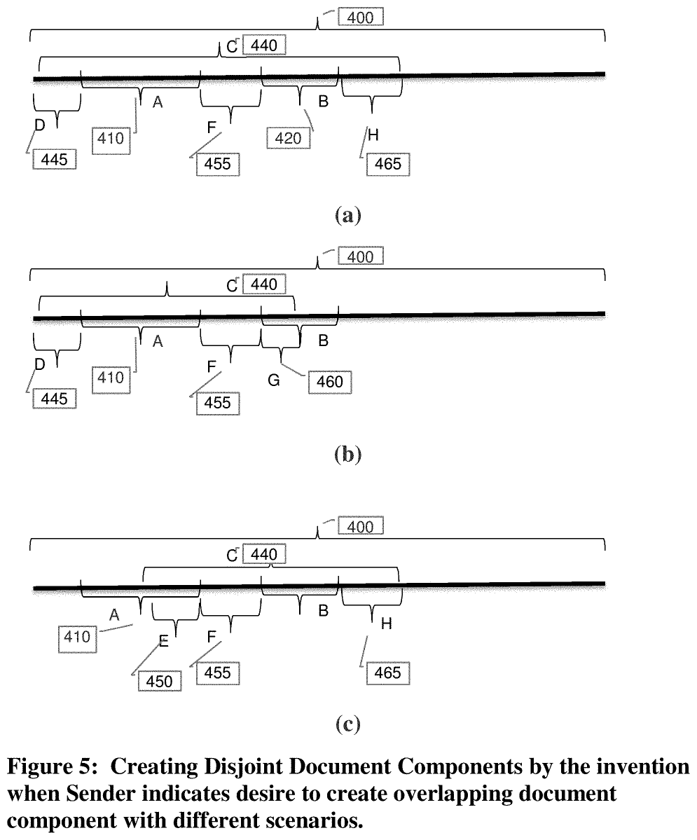

This construction also implies that document components can only be disjoint sets or subsets of each other. They can never be overlapping sets. For instance, if a sender indicates a desire through the user interface to create a new document component “C” (440) that overlaps two existing components “A” (410) and “B” (420), the new component is broken down into disjoint components “D” (445), “E” (450), “F” (455), “G” (460) and “H” (465) as follows and as shown in FIG. 5:

D=Pre{C−(A∪B)}, E=B∩C, F=Mid{C−(A∪B)}, and G=B∩C and H=Post{C−(A∪B)}.

Not all of these segments are present in every scenario. For instance for the case depicted in FIG. 5 (a), sets E and G are identical to sets A and B, so they are not needed. In FIG. 5 (b), set H is absent while set E is identical to set A. In FIG. 5 (c) set D is absent and set G is identical to set B. There are other scenarios possible too for instance when A and B are contiguous set F will be null etc. It is important to note that there is no document component “C”, in this structure.

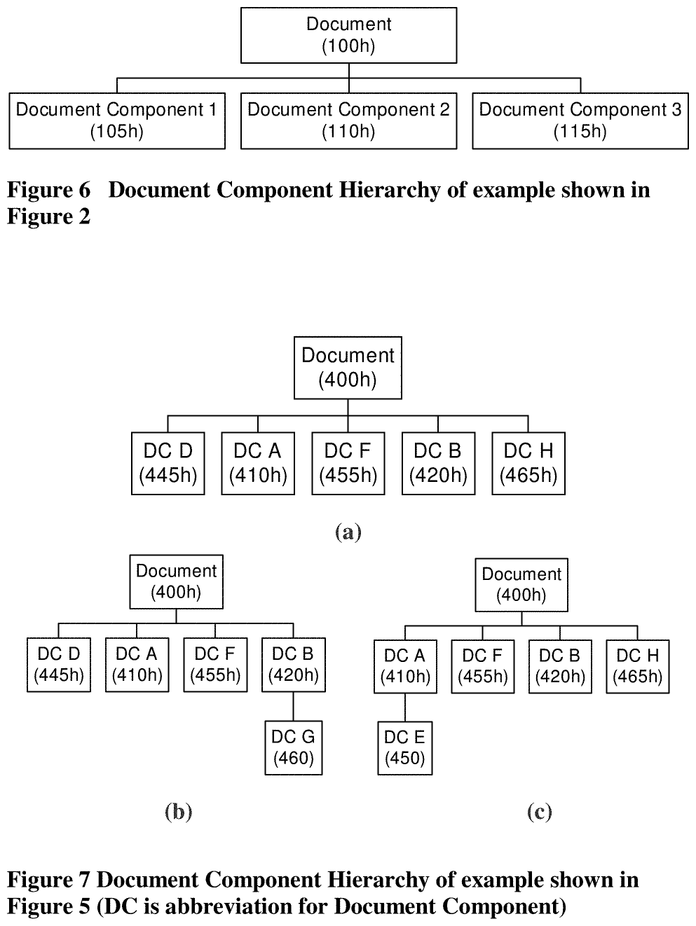

We mentioned that document components form a non-binary tree with unlimited number of levels. A simple example is shown in FIG. 6 which shows the document component tree of example shown in FIG. 2 The Document (100), and the Document Components (105), (110), and (115) of FIG. 2 are depicted as (100h), (105h), (110h), and (115h), respectively in FIG. 6. Note that the Document is always the root of such document component trees. Furthermore, note that due to our construction, all document components at a given layer are disjoint, and children of a node are (disjoint) subsets of the parent. As mentioned before, since our document is sequential, i.e. it can be modelled as a line segment, we can impose a convention that at any layer, the left most node of the tree represents the document component that is closest to the beginning of the parent, and other children are sequentially arranged as leaves of the parent as they occur sequentially in the parent.

FIG. 7 shows three document component trees that correspond to hypothetical examples shown in FIG. 5.

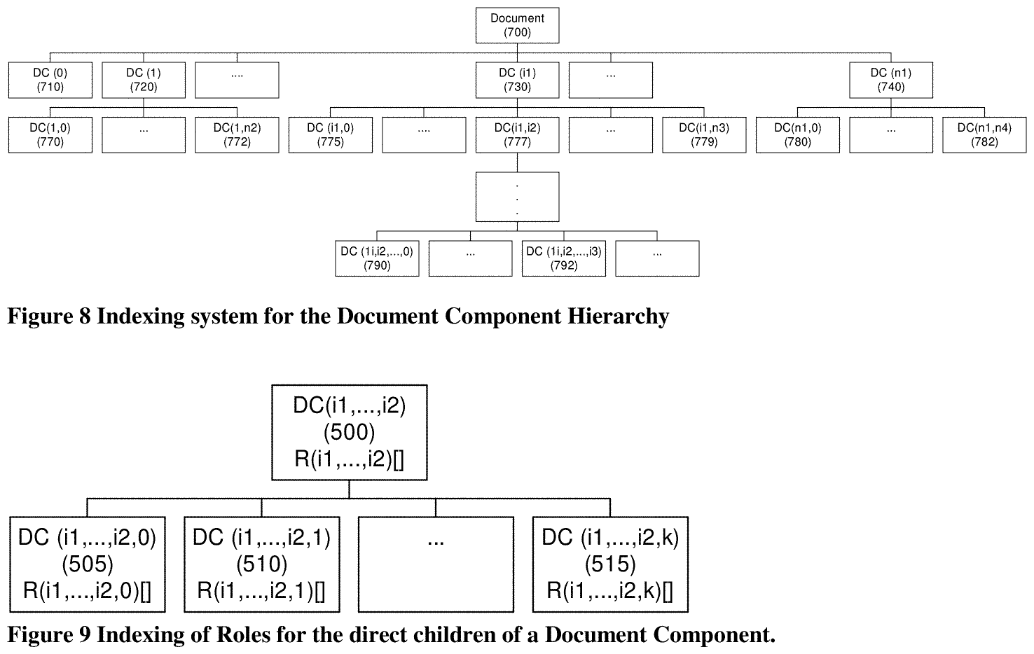

FIG. 8 shows how the invention indexes the document components. The Document (700) is considered at layer 0, and has no index. The components at the first layer e.g. (710, 720, 730, 740) are indexed from 0 through a finite integer n₁, with the general index i₁ (for 730). Every subsequent layer adds a sub-index. For instance, children of DC(1) (710) are indexed as DC(1,0) (770) through DC(1, n₂) (772), those of DC(i₁) (730) are indexed from DC(i₁,0) (775) through DC(i₁, i₂) (777) to DC(i₁, n₃) (779). The number of sub-indices increases by each layer. Some of the components in the last layer that fall in the sub tree of DC(i₁, i₂) (777) are shown as (790 and 792) and the indices are represented as (i₁, i₂, . . . ,0) and (i₁, i₂, . . . , iₖ).

During the description of FIG. 4 it was mentioned that each document component has a list of roles. To be precise, this list can be represented by a list R[ ], which is also a set in the sense that each element is unique, but specific embodiments can choose to sort this set as a list for efficient implementations. As a person with ordinary skill in the art will recognize that many such sortings are possible, and changing the sorting sense does not have any bearing on the innovation of the invention. The set of roles for each document component can also be indexed with the same index assigned to the document component, for instance The set of roles of DC(i₁, i₂) (777) is R_{(i1, i2)}[ ] (777). Please, note that it is important to realize that there is one constraint on this set R[ ] for any Document Component: it should be a union of all Roles of children of that document component. Children DC_{(i1, . . . , i2,0)} (505), DC_{(i1, . . . , i2,1)} (510), . . . , DC_{(i1, . . . , i2,k)} (515) of a generic Document Component DC_{(i1, . . . , i2)} (500) at a generic layer in the said tree are shown in FIG. 9. The said constraint implies that R_{(i1, . . . , i2)}=Uⱼ₌₀^{k} R_{(i1, . . . , i2,j)}. When applied recursive in a bottom-up fashion, this constraint implies that R_{(i1, . . . , i2)} is the union of the roles of the entire subtree (roles of all descendants).

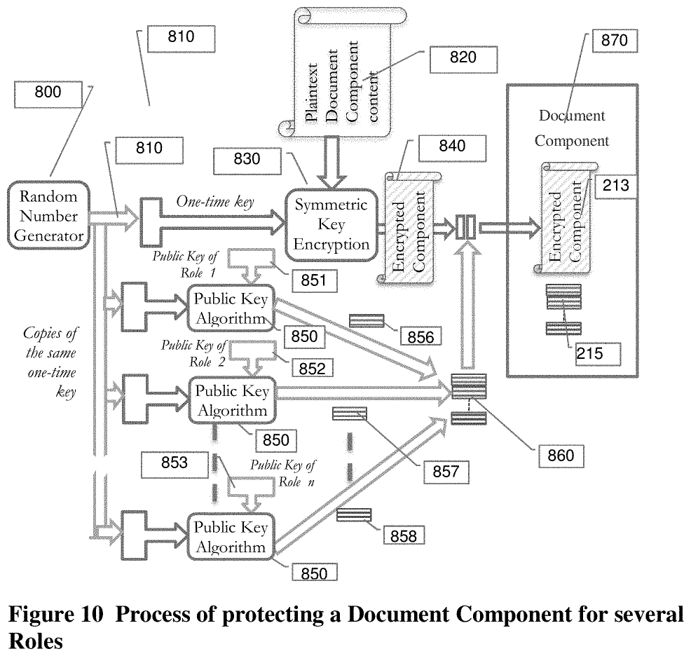

As mentioned earlier and now shown in FIG. 10, every document component encrypts the entire contiguous content (820) with a unique randomly generated symmetric key (810) Kₛ using a random number generator (800). The key Kₛ (810) is generated in a manner that is compatible with the symmetric key encryption algorithm specified by the cipher suite of the document. The document component content in plaintext form (820) is optionally compressed (not shown) and encrypted by the said symmetric key algorithm (830) using the said key Kₛ (810) as well as an IV as needed (not shown), to produce encrypted form of the document component (840). This said symmetric key Kₛ (810) is further repeatedly encrypted by public key algorithm (850) specified by the cipher suite of the document using the public keys (851, 852, 853) that belongs to each role that is authorized to access that Document Component. If n Roles (217) have access to the document, then the corresponding public keys are represented by K^{u}₁, K^{u}₂, . . . , K^{u}ₙ, respectively for each role. The multiple encrypted versions of the said symmetric key Kₛ, are collected in the list symmetricKeys[ ] (215) and stored together with Encrypted version of the component inside the object (870) of the class Document Component (200 of FIG. 4).

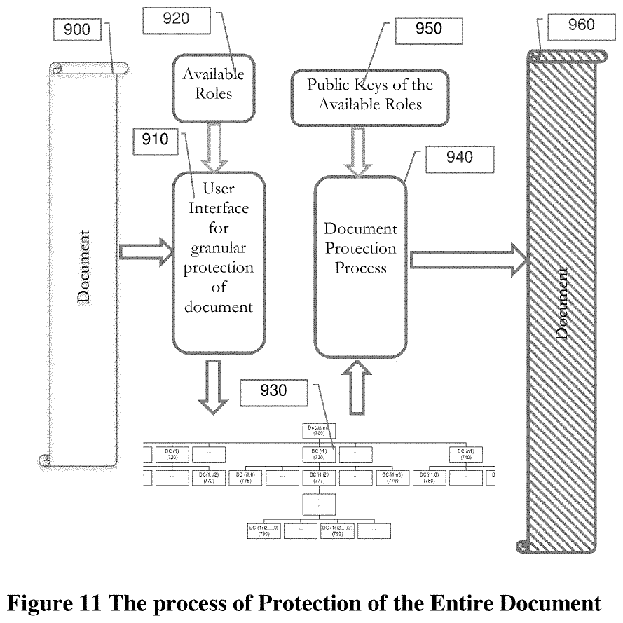

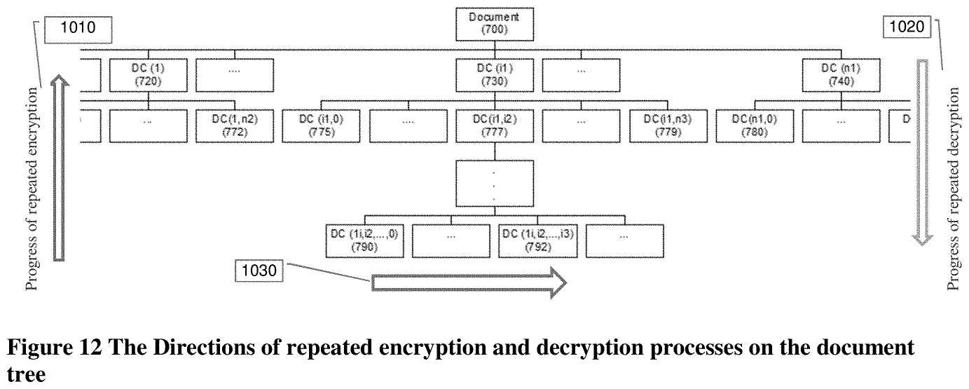

The preferred embodiment of this invention follows the following process for protecting the entire document as shown in FIG. 11. Through a user interface (910) the sender assigns roles to each document component by picking from available roles (920). Please note that the process of assigning roles is not restricted to the “disjoint” requirements as specified previously. The embodiment is capable of accepting the intention of the user and determining the document components as already described during the description of FIG. 5. When assigning roles to the document components, the preferred embodiment ensures that one constraint is met: for a given document component that has children or an entire subtree, union set of all the roles of the children is used. Once the roles are assigned to each document component and the document component tree (930) has been determined, the process of protection of the document components (940) begins in a bottom up fashion starting from the highest numbered (say n) layer (the bottom-most layer) and starting from lowest index as shown in FIG. 12 (1010, and 1030). At this stage the public keys (950) of the roles that were assigned are used. Once a document component's content is optionally compressed and then encrypted as described during the description of FIG. 10, the original plaintext is replaced (substitution) by the serialized document component object. Alternative embodiment can also convert the component to base64 or other convenient encoding formats to maintain compatibility with conventional transports. Once the document components of layer n are all encrypted and substitutions made, the same process is repeated for layer (n−1). The process is repeated for layers n, (n−1), through layer 0. Note that Layer 0 is always a single Document Component consisting of the entire document, so at this last stage the entire protected document (960) will be available.

To access information in a protected document, the receiver must have access to the private key of at least one of the roles assigned to at least one of the document components. The details of how private keys for the roles are delivered to all the recipients are discussed later. The decryption process proceeds in a top-down (1020) left-to-right (1030) fashion in the document component tree as shown in FIG. 12. To be able to invoke a role on a specific document component, that role must have access to all of the parents document components of that said document component. This is guaranteed due to the constraint on roles that was discussed in description of FIG. 9.

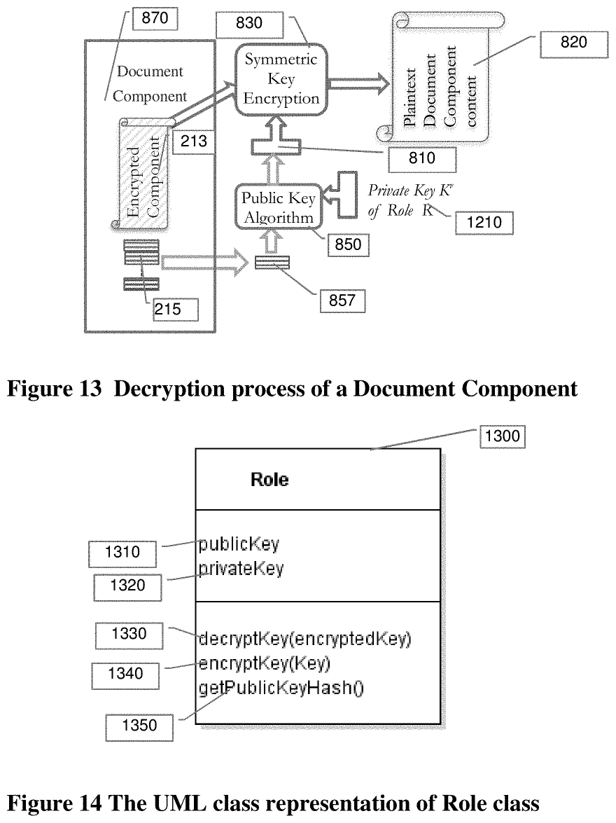

FIG. 13 shows how a specific document component (870), is decrypted. Based on the role invoked by the receiver, corresponding encrypted key (857) from the list symmetricKeys[ ] (215) is picked. The private key K^{v} (1210) corresponding to the said invoked role is R used to decrypt key the Kₛ (810) using the public key algorithm (850) specified by the cipher suite of the Document. The encrypted content (213) of the Document Component object (870) is then decrypted by the Symmetric Key Algorithm (830) specified by the cipher suite of the Document using the said decrypted key Kₛ (810) to recover the plaintext of the content (820) of the document component object. The serialized version of the encrypted document component in the Document is then replaced by the plaintext (substitution). If this Document component has children that are not authorized by the said invoked role, that document component will not be exposed because it will remain encrypted for that role. This process is carried out repeatedly for all the document components from top to the bottom.

FIG. 14 shows the class Role class (1300). All roles mentioned earlier are objects (instances) of this class. This figure shows that every Role has an associated public key and a paired private that are compatible with the public key algorithm (850) specified by the cipher suite of the document. When a new role object is created, a new public-private key pair (K^{u}, K^{v}) is generated using the random number generator (800) as a person with ordinary skills in the art will recognize. A role object is uniquely recognized by the hash value of the public key. This hash value can be obtained any time by invoking the function getPublicKeyHash( ) (1350). Alternate embodiments, may decide to cache this as a third attribute of the class for quick access. The said hash is used as a unique identifier of the role object. The Role class also provides encryptKey(Key) function (1340) that takes a randomly generated symmetric key Kₛ (810) and encrypts it using the said public key algorithm (850) to produce an encrypted version of the key e.g. 857. The Role class also provides a decryptKey(encryptedKey) function (1330) that provides the reverse function to decrypt a provided encryptedKey.

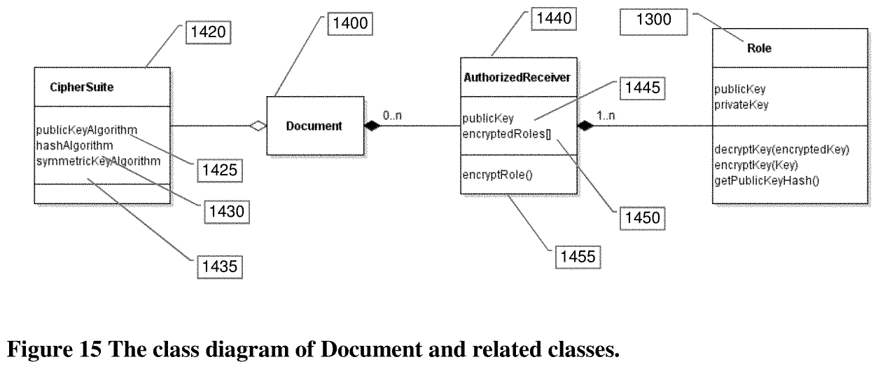

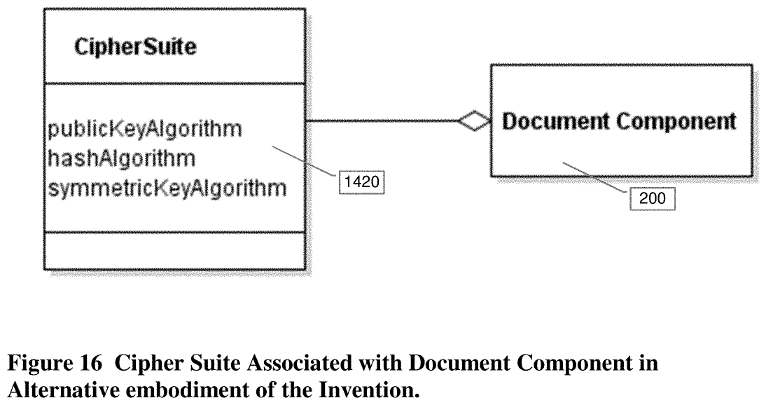

FIG. 15 shows that the Document (1400) has one instance (object) of type Cipher Suite (1420) which specifies the public key algorithm (1425), hash algorithm (1430) and symmetric key algorithm (1435) to be used throughout the document for the purpose of protection. Alternative embodiments include additional types of algorithms based on the types of protections they want to provide, for example algorithms to provide non-repudiation service such as the digital signature algorithm (DSA). An alternative embodiment associates the Cipher Suite with every or selected document components as shown in FIG. 16. In case, where a cipher suite is associated with the parent as well as the child document component of that parent, the child's document cipher will be used. If a document suite is not available for a child, the nearest predecessor's document suite will be applicable. Therefore, in the trivial case, when only one Cipher Suite is associated with the Document, the functionality is identical to the preferred embodiment.

The Document also “Contains” a list of authorized receivers each of which is an object of Authorize Receiver class (1440) of FIG. 15. Each AuthorizedReceiver is authorized to view various document components of the document that are determined by the roles as has already been described. Each authorized receiver therefore has one or more roles object (1300) that has been described already. When the Document is prepared for delivery to one or more receivers, all of the roles for a specific authorized receiver are serialized and encrypted individually using encryptRole( ) (1455) function by any encryption mechanism using the said cipher suite as a person with ordinary skill in the art would understand and using the public key (1445) of the object of the AuthorizedReceiver (1440). The encrypted versions of all the said roles is maintained in the encryptedRoles[ ] list (1450). The list of authorizedReceivers that are “contained” in the Document is then serialized. In the preferred embodiment, the said serialized version of the list of authorizedReceivers is appended to the Document and the Document can be sent to one or all of the authorized receivers. In an alternative embodiment, for additional protection, roles are encrypted in real time online and provided to the authorized authenticated receiver when the said receiver invokes a specific role. Furthermore, these roles may only be provided to the authorized authenticated receiver, if the receiver also meets one or plurality of other criteria, such as time and location constraints, number of times that the receive has viewed the content, as well as proofs provided with multi-factor authentication mechanisms. The said location information can be obtained from other side channels such as IP address, GPS location or any other mechanism. Multi-factor authentication can be based on any of the prevalent approaches including proving ownership or possession of a token or device, biometrics, as well as any type of behavioral analysis.

What is claimed is:

1. A system to protect plurality of disjoint components of a text or a binary document that is treated as a stream comprising:
a. a random number generator capable of providing adequate randomness to support generation of public-private keys for plurality of asymmetric key algorithms that the system supports;
b. a plurality of asymmetric-key cryptographic algorithms that the system supports and that are adequate to encrypt small pieces of data such as symmetric keys for a plurality of symmetric key algorithms that the system supports;
c. a plurality of asymmetric-key cryptographic algorithms that the system supports and that are adequate to provide integrity and non-repudiation to a piece of text or binary data;
d. a plurality of symmetric key cryptographic algorithms that the system supports that is adequate to encrypt any piece of text or binary data;
e. a plurality of hash algorithms that the system supports, where each is used to provide integrity and non-repudiation in conjunction with one of the said public key algorithms and is also used to provide a hash of the public key that acts as a unique identifier; and
f. a role based access control system that creates roles each with associated public-private key pair and associates that role to a single or plurality of document components.

2. A system to protect plurality of disjoint components of a text or a binary document of claim 1 further comprising:
a. a user interface to allow users to specify which roles can access or verify specific portions of the text or binary document that is treated as a stream; and
b. a mechanism for partitioning the document into multiple layers of disjoint document components such that all document components at a given layer are disjoint.

3. A system to protect plurality of disjoint components of a text or a binary document of claim 1 further comprising the system to assign multiple roles to each document component that can access or verify the said document component.

4. A system to protect plurality of disjoint components of a text or a binary document of claim 1 further comprising:
a. the system to assign multiple roles to each document component that specify all of the roles that can access the document component;
b. encrypting the symmetric encryption key by the public key of each of the said roles and maintaining all encrypted versions of the said symmetric key with the said document component; and
c. a system to decrypt the document component with the private key of any one of the said roles.

5. A system to protect plurality of disjoint components of a text or a binary document of claim 3 further comprising a system to prepare the said binary document for delivery to one or more receivers, in such a way that
a. all of the roles for a specific authorized receiver are serialized and encrypted individually by any encryption mechanism using the said cipher and using the public key of the authorized receiver; and
b. the encrypted versions of all the said roles are maintained in an encrypted roles list

6. A system to protect plurality of disjoint components of a text or a binary document of claim 5 further comprising a system to append the said encrypted roles list of the document so that the said document can be sent to one or plurality of the authorized receivers.

7. A system to protect plurality of disjoint components of a text or a binary document of claim 5 further comprising a system to maintain the said encrypted roles in the document on a server and to make the said encrypted roles that are specifically requested available to any of the said authorized receivers upon request.

8. A system to protect plurality of disjoint components of a text or a binary document where the roles are maintained on the server and downloaded in real time to when the receiver accesses the document of claim 7 where the server only allows such access if
a. the receiver accesses the document within the permitted time-period; or
b. the receiver accesses the document from a permitted physical or virtual location, determined by a GPS, an IP address, cell phone data or any other mechanism that can be used to determine the location of the receiver, or any combination thereof; or
c. the number of times the receiver has accessed the document is less than the maximum access limit specified for the role.

9. A system to protect plurality of disjoint components of a text or a binary document where the roles are maintained on the server and downloaded in real time to when the receiver accesses the document of claim 7, where the server only allows such access if the receiver provides adequate proof of its authenticity through
a. well established single or multi-factor authentication mechanisms including proving ownership or possession of a token or device; or
b. passwords; or
c. possession of biometrics; or
d. behavioral analysis; or
e. any combination of thereof.

10. The method of protecting disjoint components of a text or a binary document using cryptography and
a. treating the said document as a linear stream of information; and
b. protecting different components of the document using different cryptographic keys.

11. The method of protecting disjoint components of a text or a binary document using cryptography of claim 1, wherein a disjoint component is protected by encryption.

12. The method of protecting disjoint components of a text or a binary document using cryptography of claim 1, wherein a disjoint component is protected for integrity or non-repudiation using digital signature

13. The method of protecting disjoint components of a text or a binary document using cryptography of claim 1, wherein a disjoint component is protected by encryption for confidentiality, and integrity or non-repudiation using digital signature.

14. The method of protecting disjoint components of a text or a binary document using cryptography of claim 1, wherein each of the said disjoint components is protected by encryption using a single symmetric key using symmetric key cryptography and the said symmetric key is further encrypted by one or plurality of public keys using asymmetric-key cryptography.

15. The method of protecting disjoint components of a text or a binary document using cryptography of claim 1, wherein each of the said cryptographic key protecting each of the said protected components corresponds to a specific role that owns the corresponding private key to the said public key.

16. The method of protecting disjoint components of a text or a binary document using cryptography of claim 1, wherein the algorithms and sizes of the keys used are specified by a cipher suite for the Document or for the document component.

17. The method of protecting disjoint components of a text or a binary document using cryptography of claim 1, wherein each document has a plurality of document components such that
a. document components are organized in multiple layers; and
b. all document component at a specific layer are disjoint

18. The method of associating a role with a public-private key pair so that
a. the role is uniquely identified by the public key or the hash of the public key;
b. the role is used for protection of at least one document component;

19. The method of associating a role with public-private key pair of claim 18, where as
a. the public key of the said role is used to encrypt one or a plurality of document components in a text or a binary document that is treated as a linear stream; and
b. the private key of the said role is used by the authorized user to decrypt one or a plurality of document components in a text or multimedia document that is treated as a linear stream.

20. The method of associating a role with public-private key pair of claim 18, where as
a. the private key of the said role is used to provide non-repudiation and integrity protection of one or a plurality of document components in a text or a binary document that is treated as a linear stream; and
b. the public key of the said role is used by the user who wants to verify the authenticity and integrity of the said document component of one or a plurality of document components in a text or a binary document that is treated as a linear stream.

21. The method to protect plurality of disjoint components of a text or a binary document of claim 18 further including the process of preparing the said binary document for delivery to one or more receivers, in such a way that
a. all of the roles for a specific authorized receiver are serialized and encrypted individually by any encryption mechanism using the said cipher and using the public key of the authorized receiver; and
b. the encrypted versions of all the said roles are maintained in an encrypted roles list

22. The method to protect plurality of disjoint components of a text or a binary document and the process of preparing the said binary document for delivery to one or more receivers of claim 21 further including the process to append the said encrypted roles list of the document so that the said document can be sent to one or plurality of the authorized receivers.

23. The method to protect plurality of disjoint components of a text or a binary document and the process of preparing the said binary document for delivery to one or plurality of receivers of claim 21 further including the process to maintain the said encrypted roles list of the document on a server and to make encrypted roles that are specifically requested available to any of the said authorized receivers upon request

24. The method to protect plurality of disjoint components of a text or a binary document where the roles are maintained on the server and downloaded in real time to when the receiver accesses the document of claim 23 where the server only allows such access if
a. the receiver accesses the document within the permitted time-period; or
b. the receiver accesses the document from a permitted physical or virtual location, determined by a GPS, an IP address, cell phone data or any other mechanism that can be used to determine the location of the receiver, or any combination thereof; or
c. the number of times the receiver has accessed the document is less than the maximum permitted limit specified for the role.

25. The method to protect plurality of disjoint components of a text or a binary document where the roles are maintained on the server and downloaded in real time to when the receiver accesses the document of claim 23, where the server only allows such access if the receiver provides adequate proof of its authenticity through
a. well established single or multi-factor authentication mechanisms including proving ownership or possession of a token or device; or
b. passwords; or
c. possession of biometrics; or
d. behavioral analysis; or
e. any combination of thereof.
